(19) United States
(12) Patent Application Publication
(10) Pub. No.: US 2002/0177984 A1
(43) Pub. Date: Nov. 28, 2002

(54) Target simulation system

(75) Inventors: Karl Kautzsch, Schwanstetten (DE); Andreas Ganghofer, Nurnberg (DE); Gunther Thurner, Schwaig (DE); Jurgen Tengler, Altdorf (DE)

Correspondence Address: Leopold Presser, Scully, Scott, Murphy & Presser, 400 Garden City Plaza, Garden City, NY, 11530, US

(73) Assignee: Diehl Munitionssysteme GmbH & Co. KG, Rothenbach (DE)

(21) Appl. No.: 10/146,851

(22) Filed: May 16, 2002

(30) Foreign Application Priority Data
May 22, 2001 (DE) 101 24 850.4

(51) Int. Cl. G06G 7/48

(52) U.S. Cl. 703/6

(57) ABSTRACT

In a target simulation system for measurement and functional testing of an active optronic target tracking system its search head (12) which is mounted on a turntable (11), a pilot beam source (26), a target simulation beam generator (21) and a test camera (20) are directed on to the same side of a projection surface (18). By means of a pilot beam (27), defined points, provided with sensors (25), of the projection surface (18), relative to the apparatus installation, and then the directional control of the turntable (11), are measured. The search head receiver (14) controls tracking of a target simulation point (23) which moves over the projection surface (18) and whose movement is detected in terms of co-ordinates by the camera (20) in order to compare same to the search head movement. For that comparison operation, a co-ordinate transformation procedure is carried out, because the axes of the target simulation beam generator (21) and the search head (12), which are directed on to the same imaginary target point 16 behind the projection surface (18), pass through the surface (18) at different points (19, 23).

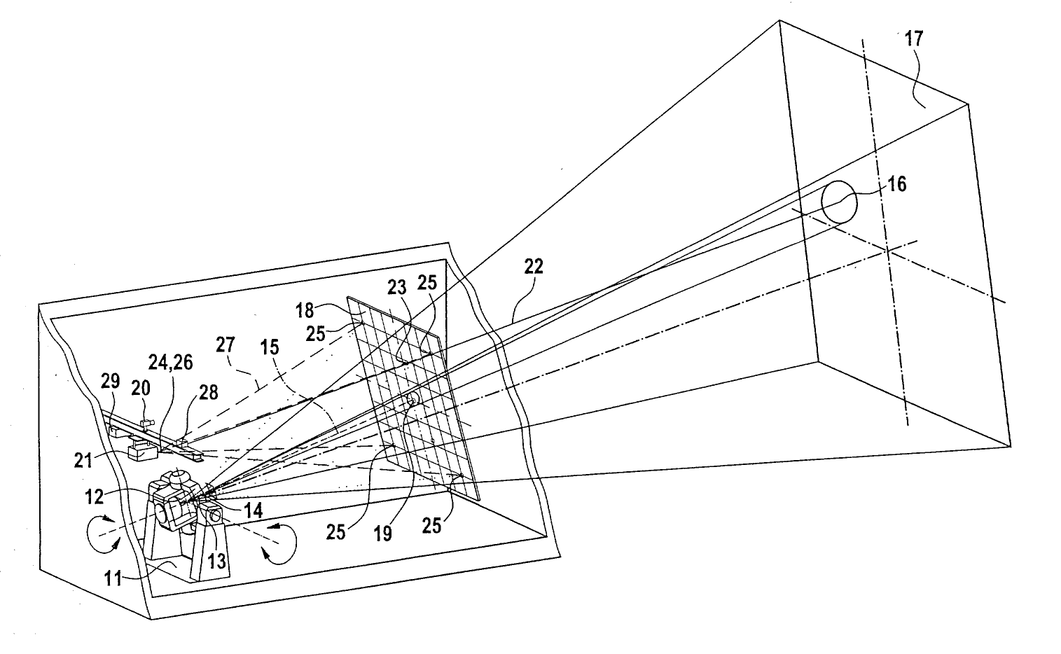

The invention concerns a target simulation system as set forth in the classifying portion of claim 1.

Such a system is known from DE 197 43 652 A1 for measuring and optimising non-image-processing target tracking apparatuses with a laser search head. By means of a deflection system referred to as a scanner, the beam of a target simulation laser is guided on to a projection surface and represented there as a point which is movable over that surface. In addition the beam of a tracking light source as a search beam generator is deflected by way of a double-axis mirror scanner for the purposes of producing the image of a further point on the projection surface. The deviations between the two point tracks which can be distinguished from each other for example in terms of colour are a measurement in respect of the quality of the target tracking program to be optimised. It will be noted however that, to provide for such direct track comparison, the endeavour is that both points draw identical reference tracks. If however mutual apparatus shading effects are to be avoided, this can only be implemented by the two points being projected on to a translucent surface from mutually opposite sides. By virtue of the double depth of installation, that necessitates an installation of very large volume because the beam sources may not be too close to the projection surface in order to avoid intolerable distortion phenomena in the event of major deflections on the projection surface; especially as a curved projection surface, for avoiding such distortion phenomena, can be implemented only for the concave side, while in opposite relationship on the convex surface the distortion effects would be still further increased. In addition the projection systems are poorly harmonisable over their entire range of pivotal movement if they are disposed on different sides of the projection surface.

In consideration of those factors the object of the invention is to develop a system of the general kind set forth, in such a way that the mode of operation of an active optronic target search head can be directly statically and dynamically measured in a space-saving simulation arrangement which can be reliably and in particular reproducibly calibrated.

In accordance with the present invention that object is attained in that—as set forth by the combination of features of the main claim predetermined co-ordinates in the projection surface, provided with punctiform individual sensors (or optical fibre ends which lead to a common detector) are provided as beam calibration points. They are encountered on the one hand by the target simulation beam and on the other by the search beam of the search head, in succession, in order to locate the relative position of the projection surface with respect to the installations. At the same time, for the directions in space in relation to the test co-ordinates in respect of which bearings have been successively taken, the associated control parameters for the turntable which is pivotable in all directions in space and for the target simulation laser are stored. So that the laser source of the search head does not have to be specifically operated on the turntable, a laser pointer or better still a laser range measuring device can be mounted at the point of rotation, for locating the turntable by surveying measurement. In that way, in relation to those co-ordinates, it has been possible to quantitatively detect both the point movement of the target simulation beam and also the tracking movement of the search head.

The search head to be tested is provided with detectors for target tracking purposes, that is to say here in the simulation system for tracking the projection point of the target simulation beam on the projection surface. The point movement can be recorded by a test camera which detects the projection surface and compared in an evaluation computer to the turntable movement initiated for point tracking purposes by the receiver of the search head.

In the comparison of the instantaneous position co-ordinates of the spatial orientation of the simulation beam generator and of the turntable with the search head on the projection surface, it is to be borne in mind that the projection surface whose bearings are taken from those two sources at different angles is far in front of the physical target plane in which the two directions of view thereof cross. The actual projection point of the simulation generator and the imaginary projection point on the search head axis do not therefore coincide if the bearing of a target point behind the projection surface is taken from both devices. In order to take that into account, the procedure involves trigonometric position transformation by way of the defined sensor-equipped locational coordinates in the projection surface.

An electrically actuable filter for beam attenuation for representation of the target simulation point can imitate different distances between the search head and the imaginary physical position of the target point reflecting the search beam.

For the purposes of additional description of the invention and the advantages thereof, including also in regard to advantageous developments, besides the further claims reference is also made to the description hereinafter of a preferred embodiment of the structure according to the invention which is shown in diagrammatic form in the drawing in abstracted manner, being limited to what is essential, but approximately true to scale.

The single FIGURE in the drawing shows the beam-geometry relationships between the search head or target simulation beam generator, projection surface and physical (imaginary) plane of movement of the target.

The target simulation system according to the invention for the static and dynamic functional test and measurement of an active optronic target tracking system operates with a three-dimensionally pivotable turntable 11, on which is mounted the active optronic target search head 12 which is to be tested in respect of its target tracking accuracy. The head 12 is provided with a laser search beam generator 13 for beaming the target 16 and with the detectors of a directionally sensitive optronic receiver 14 for target reflections. The search beam 15 of the generator 13 however is not required for the simulation.

The target object 16 which is only imaginary here moves in a physical target plane 17 which is far away from the turntable 11, behind the projection surface 18. This in contrast is disposed comparatively close to the search head 12. On same, the spatially pivotable simulation beam 22 produces a suitably moving search point 23. That point movement is detected by a test camera 20 which is installed fixedly in space in the relatively close proximity of the turntable 11 and is directed on to the projection surface 18, and is analysed in terms of co-ordinates by a computer 29.

Installed in the proximity of the camera 20, on the other side of the search beam generator 13, but on the same side of the projection surface 18, is a target simulation beam generator 21 whose simulation beam 22, when directed on to the imaginary target object 16, passes through the projection surface 18 at the target simulation point 23 and thus at a point other than the axis of the search head 12, corresponding to its search beam 15, because the two beams are directed from different starting points on one side of the projection surface 18 on to the same point 16 beyond the projection surface 18. The directional co-ordinates of the orientation of the turntable 11 therefore do not coincide with those of the target simulation beam generator for the instantaneous position of the point 23 although both are directed on to the identical target point 16. Therefore, in a computer 29, co-ordinate transformation is implemented for evaluating the target tracking accuracy of the turntable 11 which is controlled by the search head 12 in dependence on the projection point 23.

For that conversion operation, the search head axis represented as the search beam 15 and the simulation beam 22 as well as the image of the test camera 20 are to be calibrated in terms of co-ordinates, in relation to the projection surface 18. For that purpose, small-area sensors 25 are installed in the projection surface 18 at given locational co-ordinates which correspond to given spatial directions in relation to the turntable 11 and in relation to the target simulation generator 21 and also in relation to the orientation of the test camera 20. They are successively actuated by way of the scanner 24 of the target simulation generator 21, by the laser beam of a stationary pilot beam source 26, in order to locate by a surveying measurement procedure the spatial position (namely distance and inclination) of the projection surface 18 in relation to the locations of the turntable 11, the target camera 17 and the target simulation beam generator 21. That therefore defines the mounting points of the sensors 25 in space, and now the directional control of the search head 12 mounted on the turntable 11 with its search beam generator 13, the simulation beam generator 21 and the local resolution in the image of the test camera 20, can be calibrated in relation to those points.

In order to be able to imitate variable spacings of the target plane 17, that is to say different distances of the target object 16, arranged in the simulation beam 22 is a filter with adjustable damping. If therefore the imaginary geometrical intersection point of the simulation beam 22 and the search beam 15 is displaced to a greater distance behind the projection surface 18, damping of the simulation beam 22 occurs in order to represent the exponential distance dependency of the energy reflected at the target by suitable brightness variation at the target simulation point 23, which is recorded by the search head receiver 14.

In the target simulation system according to the invention for measurement and functional testing of an active optronic target tracking system therefore its search head 12 which is mounted on a turntable 11, a pilot beam source 26, a target simulation beam generator 21 and a test camera 20 are directed on to the same side of a projection surface 18. By means of a pilot beam 27, defined points, provided with sensors 25, of the projection surface 18, relative to the apparatus installation, and also the directional control of the turntable 11, are surveyed and measured. The search head receiver 14 controls tracking of a target simulation point 23 which moves over the projection surface 18 and whose movement is detected in terms of co-ordinates by the camera 20 in order to compare same to the search head movement. For that comparison operation, a coordinate transformation procedure is carried out, because the axes of the target simulation beam generator 21 and the search head 12, which are directed on to the same imaginary target point 16 behind the projection surface 18, pass through the surface 18 at different points 19, 23.

1. A target simulation system for measurement and functional testing of an active optronic target tracking system by means of a projection surface (18) on to which the movement of an imaginary target object (16) which has to follow a search head (12) can be projected by a target simulation beam generator (21) by way of a scanner (24), characterised in that the projection surface (18) is detected by a test camera (20) and at defined points is provided with sensors (25) for the pilot beam (25) of a pilot beam source (26) which is directed on to the projection surface (18) for measuringly locating the position of the projection surface (18), and that the target search head (12) is directed with the same direction of view as the test camera (20) and the target simulation beam generator (21) on to the projection surface (18).

2. A target simulation system according to claim 1 characterised in that the sensors (25) are the ends of optical fibres which lead to a common detector.

3. A target simulation system according to one of the preceding claims characterised in that a filter (28) which is controllable in respect of its damping is connected downstream of the target simulation beam generator (21).

4. A target simulation system according to one of the preceding claims characterised in that co-ordinate conversion is effected in a computer (29) for the passage points of the beam directions from the simulation beam generator (22) and the search head (12) through the projection surface (18) to the imaginary target point (16) disposed therebehind at the point of intersection of said beam directions.
